(19) United States
(12) Patent Application Publication
(10) Pub. No.: US 2018/0156954 A1
(43) Pub. Date: Jun. 7, 2018

(54) POLARIZER

(71) Applicant: Shenzhen China Star Optoelectronics Technology Co. Ltd., Shenzhen (CN)

(72) Inventors: Xiaoping CHENG, Shenzhen (CN); Yung Jui LEE, Shenzhen (CN)

(73) Assignee: Shenzhen China Star Optoelectronics Technology Co. Ltd., Shenzhen (CN)

(21) Appl. No.: 14/897,789

(22) PCT Filed: Oct. 14, 2015
(86) PCT No.: PCT/CN2015/091901

§ 371 Date: Dec. 11, 2015

(30) Foreign Application Priority Data
Sep. 25, 2015 (CN) 201510624340.6

(51) Int. Cl. G02B 5/30; G02B 1/14; G02F 1/017; B32B 7/06; B32B 7/12; B32B 33/00

(52) U.S. Cl. CPC G02B 5/3041; G02B 5/3058; G02B 1/14; G02F 1/017; B32B 7/06; B32B 7/12; B05D 1/005; G02F 2001/01791; G02F 2201/50; B32B 2250/05; B32B 2307/202; B32B 2307/748; B32B 33/00

(57) ABSTRACT

The present disclosure relates to the technical field of display, and in particular, to a polarizer applicable to a display device. The polarizer comprises a stack which includes at least the following: a first functional layer, capable of affecting a polarization direction of an optical wave; a second functional layer, capable of changing a wavelength of the optical wave; and a protective layer located at an outermost part of the stack. The integration of two important functions into the polarizer can not only improve the color gamut and the light utilization rate of the display device, but also ensure that light emitted can have a desired polarization state, thus enhancing the display quality of the display device.

### CROSS-REFERENCE TO RELATED APPLICATIONS

The present application claims the priority of Chinese patent application CN201510624340.6, entitled “Polarizer” and filed on Sep. 25, 2015, the entirety of which is incorporated herein by reference.

### TECHNICAL FIELD

The present disclosure relates to the technical field of display, and in particular, to a polarizer.

### TECHNICAL BACKGROUND

With the development of technology and the progress of society, people are becoming more and more dependent on information exchange and transfer. Display devices, as an important carrier and material base for information exchange and transfer, have become the most sought-after target in the technical field of information photo-electronics.

Quantum dots are extremely small inorganic nanocrystals that are invisible to the naked eye. Quantum dots can emit color light in response to light or electricity. The color of light emitted by a quantum dot is determined by the composition, size and shape of the quantum dot. Usually, smaller quantum dots absorb longer waves, and larger quantum dots absorb shorter waves. For example, a particular sized quantum dot can absorb the blue light of a short wavelength and emit a color light which has a long wavelength. This causes quantum dots to be able to convert the color of the light emitted by a light source.

Quantum dot display technology has been comprehensively improved in the improvement of color gamut, color accuracy, and purity of red, green, and blue light, and has been considered as a “commanding height” of global display technology and a universally influential reform in display technology. Quantum dot display technology achieves full gamut display and results in display with accurate colors.

Quantum dots are semi-conductor nanocrystals with radius smaller than or close to Bohr radius. Quantum dots are mostly made up of materials comprising groups II-VI elements or groups III-V elements and having nanoscale sizes in three dimensions. Quantum confinement effect can be observed in quantum-dot materials. Specifically, electrons and electron holes within a quantum-dot material can he squeezed into a certain dimension that approaches a critical quantum measurement, which enables the original continuous energy band to become discrete energy levels. Confinement degree of electrons and electron holes varies with the size of the quantum dot, and different confinement degree will result in different discrete energy levels. In response to an external excitation, different sized quantum dots can emit light with different wavelengths different color light.

Quantum dots have the following advantages. By tuning the size of quantum dots, light can be caused to cover the wavelength of infrared light and of the entire visible light. The light emitted has narrow wavelength and high saturation degree of color. Quantum-dot materials are efficient in optical wave conversion, stable in property, and easy to be prepared in diverse ways. For example, they can be prepared from various solutions.

However, the polarization direction of light passed through quantum dots is random. If, when the divergent light passed through the quantum dots passes through liquid crystals, the light at each pixel cannot be well controlled any more, light leak will occur in the liquid crystal display (LCD) device. A LCD device takes advantage of the optical activity and double refraction of liquid crystals. By controlling the rotation of the liquid crystals with voltage, linearly polarized light passed through an upper polarizer rotates, and then shines out from a lower polarizer (whose polarizer axis is perpendicular to that of the upper polarizer). In this manner, the polarizer and the liquid crystal cell together function as an optical switching. This optical switching, however, cannot completely control the light emitted from the quantum dots.

### SUMMARY OF THE INVENTION

The present disclosure provides a polarizer which is intended to solve the above problem of the existing technologies, i.e., polarization direction of the light passed through quantum dots is random, which is not applicable to a liquid crystal display (LCD) device.

The polarizer provided by the present disclosure comprises a stack which includes at least the following: a first functional layer, capable of affecting a polarization direction of an optical wave, a second functional layer, capable of converting the wavelength of the optical wave (In order to simplify the structure and manufacture process of a polarizer in a common sense, a wavelength converting layer is obtained by modification of a adhesive material, namely, by addition of quantum dots), and a protective layer located at an outermost part of the stack. In this manner, two important functions are integrated into the polarizer, which can not only improve the color gamut and the light utilization rate of the display device, but also ensure that light emitted can have a desired polarization state, thus enhancing the display quality of the display device.

Preferably, the second functional layer has a bonding function.

Preferably, the second functional layer is constructed by adding a quantum-dot material to a bonding material. In the present disclosure, quantum dots are mixed with a bonding adhesive. By placing the quantum dots in the bonding adhesive, the process of forming the polarizer can be simplified, better polarizing effects and more importantly, wider color gamut coverage can be achieved.

Preferably, the quantum-dot material is added to the bonding material by surface grafting or surface coating, which can achieve a more uniform and steadier mixture of the quantum-dot material and the bonding material.

Preferably, film formation of the second functional layer is achieved by spray coating, spin coating, printing, or slit coating. It can thus be seen that in the technical solution of the present disclosure, selection of processes is very flexible. Thickness of the film can be adjusted flexibly (e.g., between 0 to 10 μm) during the process, and can be large and small based on the content and the adhesiveness of the quantum dots.

Preferably, proportion of the quantum-dot material and proportion of the bonding material can be adjusted by increasing or decreasing a treating agent, resin, or a solvent. Thus, in order to achieve a better mixing effect with respect to the second functional layer of the polarizer, the proportion of each component of the second functional layer can be easily changed.

Preferably, the quantum-dot material is made of elements from groups IIB and VIA or from groups IIIA and VA, or is made of a single-element quantum-dot material.

Preferably, the quantum-dot material is made of a semi-conductor material or a mixture of more than two semi-conductor materials.

In the present disclosure, there is no special restriction to the material of the quantum-dot material in the second functional layer, as long as a material selected is suitable for improving the color gamut and achieving a good mixing effect.

Preferably, the bonding material is a polar material or a non-polar material; the quantum-dot material is an oil-soluble or water-soluble material; and the first functional layer comprises an iodine-based or dye-based polarizing material.

Preferably, the polarizer, from one side thereof to the other side thereof, comprises a first protective film, a first release film, the second functional layer, the first functional layer, an ordinary bonding layer, a second release film, and a second protective film. The first release film and the second release film protect the second functional layer and the ordinary bonding layer, respectively. The first protective layer and the second protective layer located at the outmost part of the polarizer provide chemical and mechanical protection for the polarizer as a whole.

In a summary, the polarizer provided by the present disclosure is able to solve the problem of insufficient degree of light polarization in traditional devices while improving the color gamut. By providing quantum-dot structures in the multi-layer polarizer, and mixing the quantum-dot structures with the bonding layer, the manufacturing process of the polarizer can be simplified. Further, because the quantum-dot material is located upstream of the light path of a polarizing layer, light emitted from the quantum-dot material passes through the polarizing layer and then becomes polarized light, whereby the polarization of the light is ensured. This is in particular best used liquid crystal display devices. The present disclosure is not restricted with respect to the position of the bonding layer (There is perhaps no requirement about position of the light path of the bonding layer in other applications), and is restricted with respect to this new type of polarizer and the modified bonding functional layer.

The above technical features can be combined with one another in various proper ways or replaced by equivalent technical features, as long as the objective of the present disclosure can be achieved.

### BRIEF DESCRIPTION OF THE DRAWINGS

The present disclosure will be further illustrated based on the following embodiments in conjunction with the accompanying drawings, in which:

FIG. 1 schematically shows a polarizer according to an embodiment of the present disclosure; and

FIG. 2 schematically shows a polarizer according to the existing technologies.

In the drawings, same components are indicated with same reference numbers. The figures are not drawn to scale.

### DETAILED DESCRIPTION OF THE EMBODIMENTS

The present disclosure will be explained in detail below with reference to the accompanying drawings.

A polarizer provided by the present disclosure comprises a stack which includes at least the following structures: a first functional layer, capable of affecting a polarization direction of an optical wave; a second functional layer, capable of converting the wavelength of the optical wave; and a protective layer located at an outermost part of the stack. Preferably, the second functional layer has a bonding function.

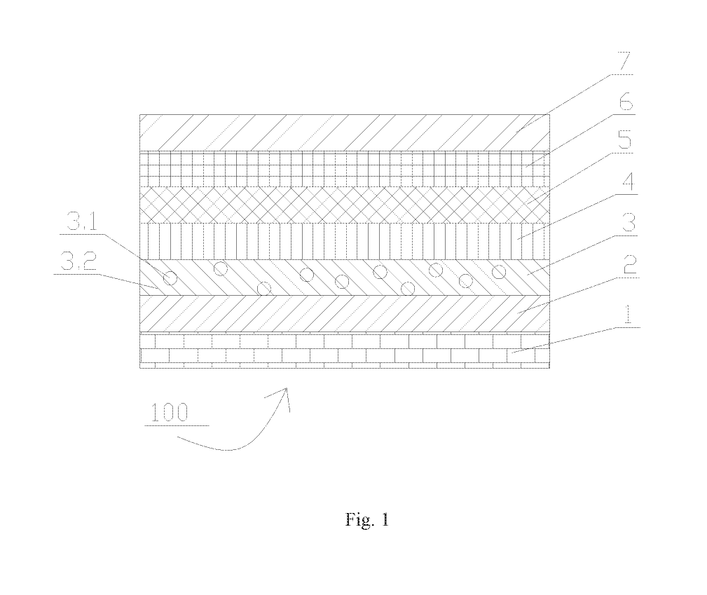

Specifically, FIG. 1 shows a polarizer 100 constructed in accordance with an embodiment of the present disclosure. The polarizer 100, from one side thereof to the other side thereof, comprises: a first protective film 1, a first release film 2, a second functional layer 3, a first functional layer 4, an ordinary bonding layer 5, a second release film 6, and a second protective film 7.

The first functional layer 4 comprises an iodine-based or dye-based polarizing material, and can affect polarization direction of an optical wave. The first functional layer 4 can be, for example, a linear polarizer. The first function layer 4 may comprise a polyvinyl alcohol (PVA) layer in the middle thereof and tri-cellulose acetate (TAC) layers on both sides of the PVA layer. It is the PVA layer that polarizes the optical wave. However, polyvinyl alcohol (PVA) can be easily undergoes hydrolyzed. Therefore, in order to protect physical properties of the first functional layer 4, the TAC layer, which has high light transmittance, good water tolerance, and a certain degree of mechanical strength, is provided at both sides of the PVA layer.

As can be seen clearly from FIG. 1, the second functional layer 3 comprises quantum-dot structures 3.1 and a bonding material 3.2.

The second functional layer 3 can be constructed by adding the quantum-dot structures 3.1 to the bonding material 3.2 in the manufacturing process. Preferably, the addition of the quantum-dot structures 3.1 to the bonding material 3.2 can be achieved by surface grafting or surface coating. A more uniform and steadier mixture of the quantum-dot material 3.1 and the bonding material 3.2 can thus be obtained by methods such as surface grafting or surface coating.

By adding the quantum-dot structures to the multi-layer polarizer, in particular, to the bonding layer, the problem of limited degree of light polarization in traditional devices can be eliminated while the color gamut is still improved.

A bonding layer containing quantum dots is obtained after a film of the mixed material is formed. The bonding layer is the second functional layer 3. The film formation of the second functional layer 3 can be achieved by means such as spray coating, spin coating, printing, or slit coating.

Proportion of the quantum-dot material 3.1 and proportion of the bonding material 3.2 can be adjusted by increasing or decreasing the content of a treating agent, resin, or a solvent. That is, in the present embodiment, the formula of the materials of the second functional layer 3 does not always remain the same. The proportion of each component of the second functional layer 3 can vary in order to obtain a better mixture. This can he achieved through simply increasing or decreasing the content of the treating agent, resin, or the solvent.

The quantum-dot material 3.1 is made of elements from groups IIB and VIA or from groups IIIA and VA. Optionally, the quantum-dot material 3.1 is made of a single-element quantum-dot material, a typical example thereof being carbon quantum-dot material.

The quantum-dot material 3.1 can also be made of a semi-conductor material or a mixture of more than two semi-conductor materials selected from, for example, CdS, CdSe, CdTe, ZnSe, InP, and InAs.

Therefore, in the present disclosure, there is no restriction to the materials of the quantum-dot material 3.1, as long as a material selected is suitable for improving the color gamut and achieving a good mixing effect.

The quantum-dot material 3.1 may be an oil-soluble or water-soluble material, and no specific restriction is made in the selection of either of the two.

The quantum-dot structure is usually a nanoparticle with a steady diameter smaller than 20 nm and with a shape of a ball, a rod, or a thread.

The bonding material 3.2 is a polar material or a non-polar material, and no specific restriction is made in the selection of either of the two.

The ordinary bonding layer 5 comprises a bonding material only, and serves a bonding function only.

The first release film 2 and the second release film 6 are provided to protect the second functional layer 3 and the ordinary bonding layer 5, respectively, The first protective layer 1 and the second protective layer 7 located at the outmost part of the polarizer 100 are used to provide chemical and mechanical protection for the polarizer 100 as a whole.

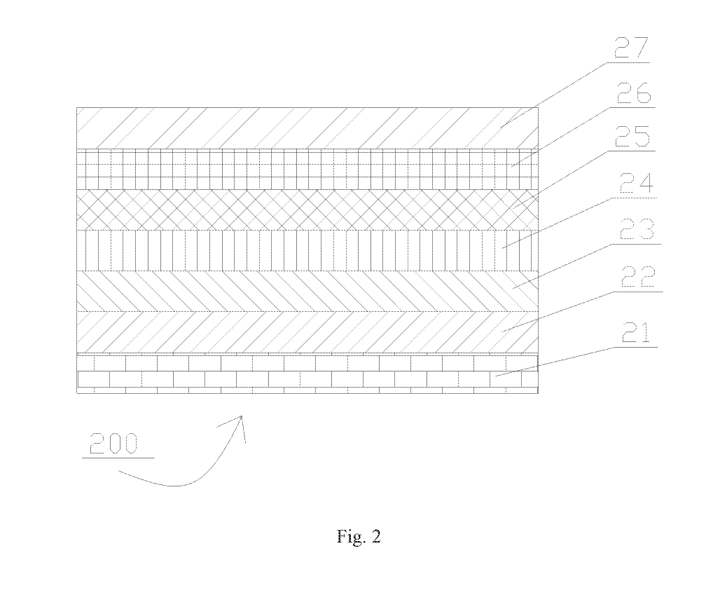

FIG. 2 shows a polarizer 200 according to the existing technologies. The polarizer 200 comprises, from one side to the other side, a first protective layer 21, a first release layer 22, a first bonding layer 23, a polarizing layer 24, a second bonding layer 25, a second release layer 26, and a second protective layer 27. It can be seen that in the polarizer 200, no quantum-dot structure is provided for converting the wavelength of an optical wave. Consequently, the polarizer 200 is greatly limited in color gamut, which in turn can affect the final display effect. Even if the excellent chromatic property of the quantum-dot structure is desired to be used in the polarizer 200, additional optical devices having quantum-dot structures have to be provided around the polarizer 200. Integration of so many devices into a display device will increase the size of the display device, the cost and complexity of manufacturing the display device, and reduce display accuracy. Besides, common quantum-dot structures may disturb the polarization state of an incident polarized light when changing the wavelength of the light, which will surely bring negative effects to a liquid crystal display device requiring much of polarization of light.

If the polarizer 100 shown in FIG. 1 and the polarizer 200 shown in FIG. 2 are compared, the following conclusions can be easily obtained. In the quantum-dot display devices manufactured according to traditional methods, polarization of light in LCD devices is mostly neglected. The light emitted by the quantum dots in response to excitation is divergent, which enables the linear polarized light in a liquid crystal cell derived after the light passes through the polarizer to become non-linear polarized light again. This is detrimental to control of light by the liquid crystal layer, and is likely to result in light leak, as a consequence of which, the contrast of the entire display device will be reduced. The technical solution of the existing technologies is thus not a desired structural solution. It is therefore necessary to eliminate the negative effect (the problem of polarization of light) caused by introduction of quantum dots in the display device in order to obtain a better display device. In the technical solution of the present disclosure as illustrated above, the quantum-dot material and the bonding material are mixed together. By placing the quantum-dot structures in the bonding adhesive, the process for forming the polarizer is simplified; a better light polarization effect is produced; and more importantly, a wider color gamut is achieved. This perfectly solves the technical problem in the existing technologies. Further, since the quantum-dot material is located upstream of the polarizing layer, the light emitted from the quantum-dot material will pass through the polarizing layer and become linear polarized light. This ensures the polarization state of the light, and is especially suitable for use in a LCD device. The present disclosure does not define the location of the bonding layer (other applications may not define the position of the light path of the bonding layer), but defines said new type of polarizer and the modified bonding functional layer.

The polarizer provided by the present disclosure has the following advantages.

(1) The technical solution of the present disclosure does not define the location of the bonding layer (i.e., the second functional layer in the multiple-layers of the entire polarizer. Said location can be adjusted as required by a specific application, though the accompanying drawing above has shown an implementing form of the polarizer of the present disclosure.

(2) The technical solution of the present disclosure does not specifically define the location of the color filter layer, the location of the array substrate, and the location of the black matrix of the LCD device. The technical solution therefore has a wide application, and can be used flexibly in various ways.

(3) The technical solution of the present disclosure is applicable to the new developed techniques such as BOA (BM on array) technique in which black matrix and array substrate are integrated together, COA (Color-filter on Array) technique in which color filter and array substrate are integrated together, and GOA (Gate driver on Array) technique in which the gate driver and an array substrate are integrated together.

(4) The polarizer provided by the present disclosure can be used as an upper polarizer (polarizer of an array substrate) or as a lower polarizer (polarizer of a color filter substrate) in a traditional LCD device.

(5) The second functional layer described above can also be used as other internal layers or external layers for achieving a similar function or other corresponding functions.

(6) The technical solution of the present disclosure does not specifically define the drive mode of the LCD device or the control mode of liquid crystals, and is applicable to IPS (In-Plane Switching) mode, TN (Twisted Nematic) mode, VA (vertical alignment) mode, OLED (Organic Light Emitting Diode) mode, QLED (Quantum Dots Light Emitting Diode) mode, etc.

The present disclosure is described above with reference to specific embodiments, but it should be noted that these embodiments are merely exemplary of the principles and applications of the present disclosure. It should therefore be understood that the exemplary embodiments can be amended in various ways and other designs can also be provided without departure from the spirit and scope of the present disclosure. One should also understand that different features in the dependent claims and the description can be combined in ways different from those described in the original claims, and that a combination of features in one embodiment can be used in other embodiments.

1. A polarizer, comprising a stack which includes at least the following:
a first functional layer, capable of affecting a polarization direction of an optical wave,
a second functional layer, capable of converting a wavelength of the optical wave, and
a protective layer located at an outermost part of the stack.

2. The polarizer according to claim 1, wherein the second functional layer has a bonding function.

3. The polarizer according to claim 2, wherein the second functional layer is constructed by adding a quantum-dot material to a bonding material.

4. The polarizer according to claim 3, wherein the quantum-dot material is added to the bonding material by surface grafting or surface coating.

5. The polarizer according to claim 3, wherein film formation of the second functional layer is achieved by spray coating, spin coating, printing, or slit coating.

6. The polarizer according to claim 3, wherein proportion of the quantum-dot material and proportion of the bonding material can be adjusted by increasing or decreasing a treating agent, resin, or a solvent.

7. The polarizer according to claim 3, wherein the quantum-dot material is made of elements from groups IIB and VIA or from groups IIIA and VA, or is made of a single-element quantum-dot material.

8. The polarizer according to claim 3, wherein the quantum-dot material is made of a semi-conductor material or a mixture of more than two semi-conductor materials.

9. The polarizer according to claim 3, wherein the bonding material is a polar material or a non-polar material, the quantum-dot material is an oil-soluble or water-soluble material, and the first functional layer comprises an iodine-based or dye-based polarizing material.

10. The polarizer according to claim 3, from one side thereof to the other side thereof, comprising:
a first protective film, a first release film, the second functional layer, the first functional layer, an ordinary bonding layer, a second release film, and a second protective film.
